(19) United States
(12) Patent Application Publication
(10) Pub. No.: US 2013/0065215 A1
(43) Pub. Date: Mar. 14, 2013

(54) Education Method

(71) Applicant: Kyle Tomson, Salem, OR (US)

(72) Inventor: Kyle Tomson, Salem, OR (US)

(21) Appl. No.: 13/412,635

(22) Filed: Mar. 6, 2012

Related U.S. Application Data
(60) Provisional application No. 61/450,125, filed on Mar. 7, 2011.

(51) Int. Cl. G09B 7/02

(52) U.S. Cl. CPC G09B 7/02
USPC 434/350

(57) ABSTRACT

An education system for educating one or more students wherein the student is presented with a setting and multiple responses. In the application of the system, one or more students provide a verbal response in accord with one of the multiple responses. The student's response is then incorporated into a dialog which is returned to the student.

### PRIORITY CLAIM

The present application claims the priority of U.S. provisional application No. 61/450,125, filed on Mar. 7, 2011, which is hereby incorporated by reference.

### FIELD OF INVENTION

This invention relates generally to a method for teaching children and more specifically for a teaching method and therapy for those diagnosed as having autism and related conditions. More particularly, the present invention teaches of an interactive method of engaging student's communicative participation and promotes normal adaptive behavior.

### BACKGROUND OF THE INVENTION

Social defect disorders, including those under the common term of autism, are prevalent in modern society. Autism, the most prevalent, is generally accepted as a neurodevelopmental disorder characterized by dysfunction in three core behavioral dimensions: repetitive behaviors, social deficits, and cognitive deficits. The repetitive behavior domain involves compulsive behaviors, unusual attachments to objects, rigid adherence to routines or rituals, and repetitive motor mannerisms such as stereotypes and self-stimulatory behaviors. The social deficit dimension involves deficits in reciprocal social interactions, lack of eye contact, diminished ability to carry on conversation, and impaired daily interaction skills. The cognitive deficits can include a wide range of defects, but often include language abnormalities. In general, people with autism often also have sequencing problems which manifest in many ways in their lives.

In the education and treatment of the autistic with a focus to the social deficit dimension, the prevailing method of teaching social skills to children has been a method called “Social Stories,” developed by Carol Gray in 1991. Gray developed a method of language scripting steps that occur in social situations that involved breaking them down into smaller behaviors. This aided students and in particular autistic students in conceptualizing proper behavior. The present invention adapts the basic Social Stories methodology of Carol Gray, adding new dynamics of interaction and feedback to provide further benefit.

One example of language scripting in the present invention is the use of a series of pictures in combination with written words that are designed to visually represent a particular scenario or idea. A given written/pictorial scripting element can present a 1:1 picture to word correspondence and can also provide a dialogue in written/pictorial form. Another example of language scripting in this invention is the use of a videotaped sequence in which visual stimuli are used to visually represent a particular idea and communicate this information to the individual watching the video. These programs aid in overcoming social deficits and sequencing disorders by providing modeling tools.

Parents have created language scripting on their own and Model Me Kids has created a video series that uses this type model of learning. http://www.modelmekids.com. This is the dominant model for teaching children social skills in the world of autism and has shown some positive results.

However, the problem with known behavior modeling systems is the lack of dynamic interaction. In known behavior modeling systems, students look at a picture or watch a video of other children modeling appropriate social behavior. The student may be presented with options and variables but the student's participation is limited to responsive participation. In known behavior modeling systems the student is not able to dynamically interact with the pictures or the videos or receive legitimate feedback.

Some people with autism are concrete thinkers and have trouble thinking in the abstract. Social situations are anything but concrete and such concrete thinkers do not have the sequencing skills to dynamically create conversations as they go along. As such, expanding a basal repertoire and pattern repetition is an important part of the world of autism education systems. Successful therapies will imprint as many situations as possible and expand the repertoire of a student's available communication skills providing the student with as many concrete scenarios as possible to fill in for the lack of abstract thinking skills.

In the early stages of Social Stories type therapies, only the visual sense was involved. Later developments moved into the auditory realm with animated video and auditory playback in what were termed Social Movies. Research has clearly shown the more senses included in a method of learning, the faster the autistic child will learn. This is confirmed in a 2006 study titled Multi-sensory training: Faster Learning, by Boston University Professor of Psychology Aaron Seitz, which can be reviewed at http://www.physorg.com/news74877506.html. Similar results have been found by other studies.

Therefore, rather than providing a flat and non-interactive model of learning, the need exists for an invention that provides an interactive and dynamic model. Rather than subjecting the student to completed sequences of conversations and asking them to simply mimic the presented behavior, the need exists for an invention that will dynamically incorporate the student into the model as an active participant. The present disclosed invention meets these needs by combining the visual, auditory, and tactile systems in a novel way and by dynamically incorporating the student into the modeling behavior.

### SUMMARY

It is therefore an object of the present invention to overcome the aforementioned disadvantages of prior art devices and provide a means to structure participation in a plurality of conversations where the student is allowed to initiate or respond to conversation points and promote constructive interaction. This system for educating students should comprise visual elements together with an auditory input phase and a feedback phase, wherein the student is presented with a conversation scenario and depending on the scenario, the student is presented with a choice of multiple responses. Once the student picks the correct response, the student is offered an input means which is satisfied when the student records the correct answer in his or her own voice. Once the student's voice response is recorded, the student may playback a generated dialog which incorporates the student's voice in sequence with a virtual voice to provide a complete conversation sequence, reinforcing the student's cognitive behavior. Further benefits are incorporated in the ability for multiple students to jointly participate in the creation of a scenario that includes a multi-party dynamic dialog generated jointly with a coherent playback in the students' own voices entirely, or in conjunction with one or more virtual voices, permitting the student to experience and learn from a complex multi-party dialog.

### BRIEF DESCRIPTION OF THE DRAWINGS

The above description and other objects, advantages, and features of the present embodiment will be more fully understood and appreciated by reference to the specification and accompanying drawings, wherein:

FIG. 1 is a flowchart showing a preferred algorithm of the present invention.

FIG. 1a is a zoomed view of the top left section of the flow chart in FIG. 1.

FIG. 1b is a zoomed view of the top right section of the flow chart in FIG. 1.

FIG. 1c is a zoomed view of the bottom right section of the flow chart in FIG. 1.

FIG. 1d is a zoomed view of the bottom right section of the flow chart in FIG. 1.

FIG. 2 shows the start screen for the preferred embodiment.

FIG. 3 shows the saved conversation screen of the preferred embodiment.

FIG. 4-6 shows the screen shots of the interface between the student and the present invention pertaining to an exemplar conversation sequence regarding catching butterflies.

FIG. 7-21 shows the screen shots of the interface between the student and the present invention pertaining to an exemplar conversation sequence regarding camping.

FIG. 22-36 shows the screen shots of the interface between the student and the present invention pertaining to an exemplar conversation sequence regarding sledding.

### DETAILED DISCUSSION OF THE PREFERRED EMBODIMENTS

Children with autism have auditory processing problems and sequencing issues. As such, social interactions are incredibly difficult. They are often unable to process conversations in real time, making them slow to respond to what others say. And because they generally do not have strong linear thinking skills they cannot ascertain how to sequence a conversation. As such, they often have conversation stoppers that are perceived as “odd” things to say. As an example, in a grade school lunch wherein all the students might have sandwiches, an autistic student may initiate a dialog with a statement of, “You have a peanut butter and jelly sandwich. I have bologna.” This is an improper manner in which to initiate engagement as it is both literal and conclusory. A proper initiation of conversation may be “I have a bologna sandwich, what do you have?” As this elicits and interactive response, even though the speaker may be able to perceive that the other party has peanut butter and jelly as the purpose of the interaction is not to obtain information requested as it is to establish communication.

A goal of the present invention is to teach children to establish interactive communication skills with dynamic interactive back and forth practice. Computer simulated conversation and scenario modeling of what might be more typical for a peer to say is used. The invention also provides the opportunity for students to practice their responses in a safe environment with each other.

Students are given the opportunity to respond to images and record their own voice. After a series of images and options for dialog are selected and recorded, the entire conversation with a student's voice played back. The student has not only the dynamic interactive experience of inputting their voice, but there is the additional auditory reinforcement of the conversation after they have gone through the input sequence. The student can hear and understand how a conversation should flow in their own voice, or in the case of a multi-party session, in their own voice and the voices of their peers either independent of or in conjunction with the voice of one or more synthetic or computer voice generated participants.

This method is an improvement over the prior art because 1) the students have the visual reinforcement with images; 2) the students have the visual reinforcement with text; 3) the students interact dynamically in a social situation; and 4) the students have the auditory reinforcement of hearing the entire conversation with their own voice, played back in real time.

While any multimedia device might be adapted for use, in the preferred embodiment, the functionality of the present invention is embodied in a software application for use on a tablet type device, preferably one with a touch-screen input. More specifically in the preferred embodiment the present application is utilized as an iPad/iPod application. Some aspects of the coding may be conventional, therefore the present invention is not limited to the specific software implementation. People skilled in the art can choose whatever tools, moods or architectures as they see fit to practice the present invention.

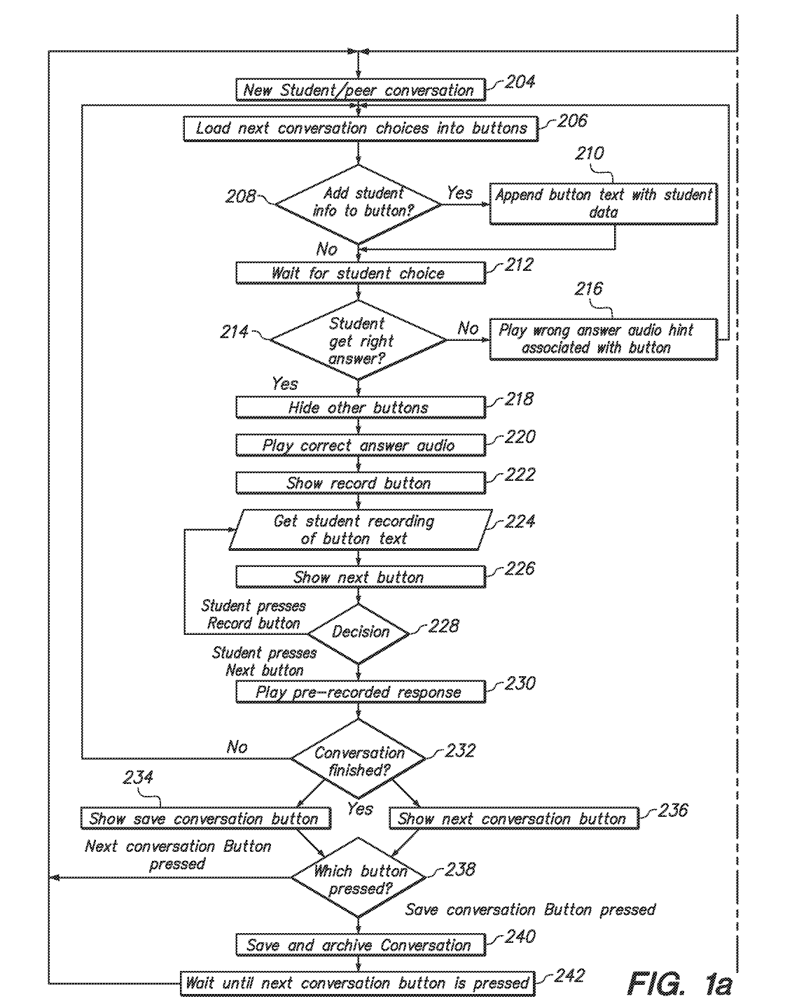

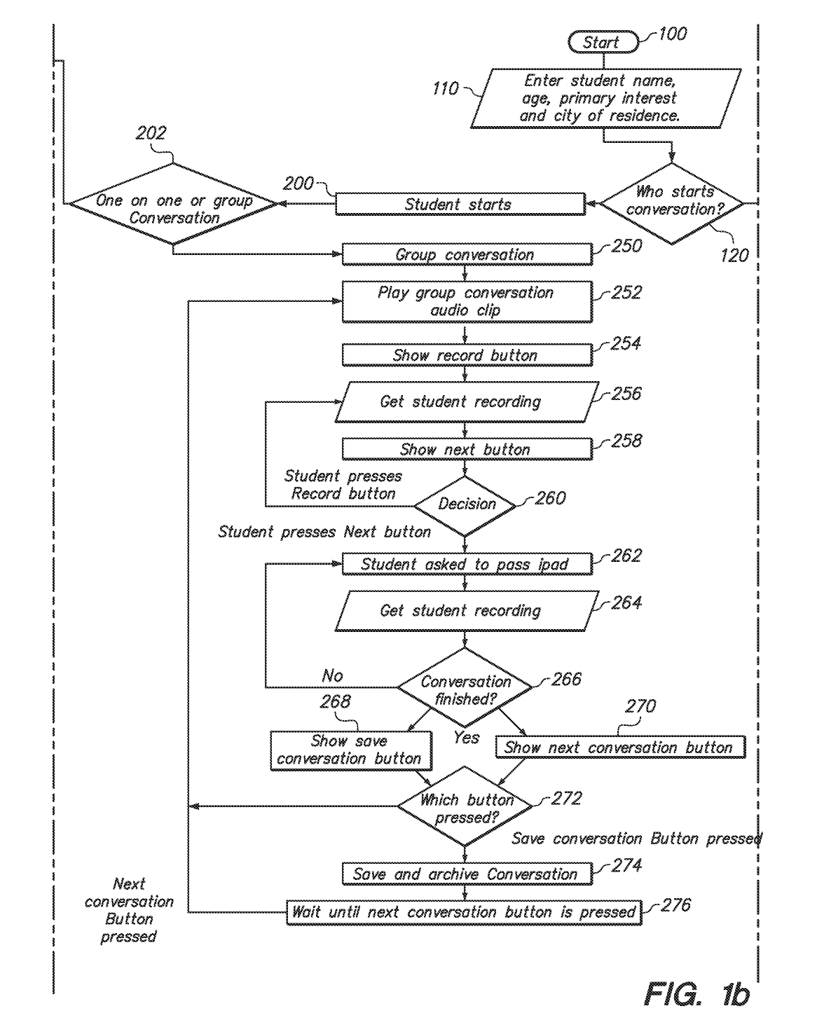

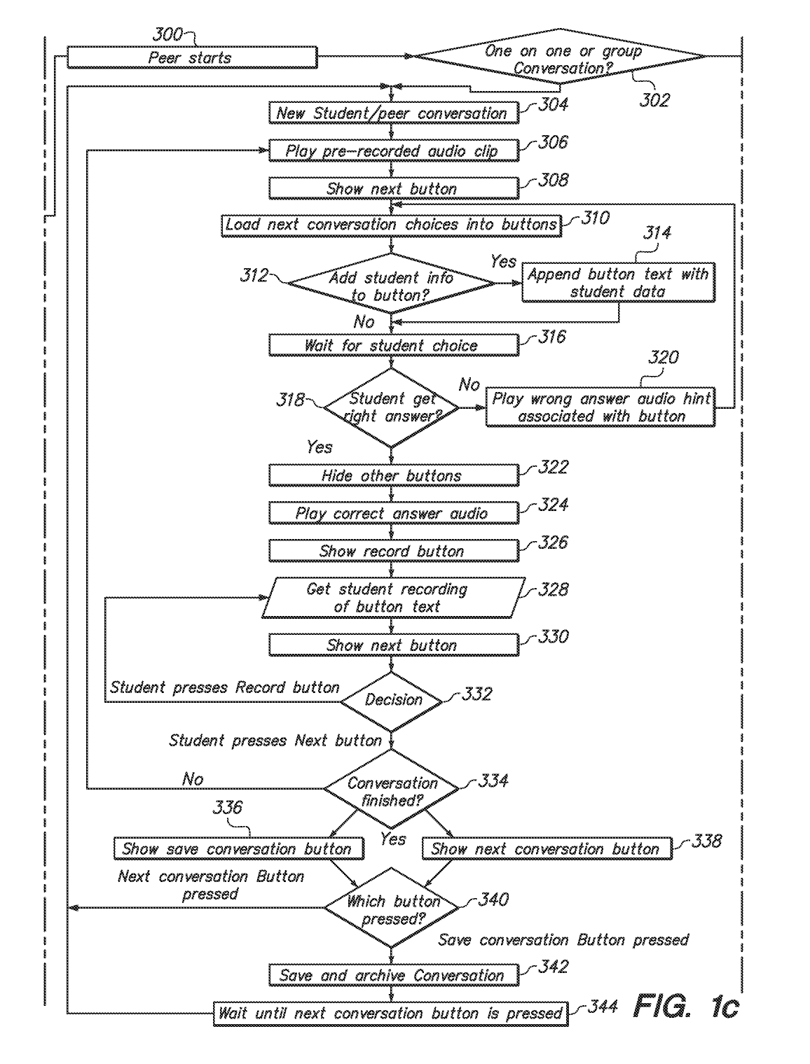

FIG. 1 shows the entire algorithm of the preferred embodiment. In the preferred embodiment, the student starts at step 100 by logging into to the application and if they have not yet registered, they may do so in step 110. Step 110 requests the student's age, interest, and contact information. In the preferred embodiment information is used within the conversation to personalize the game play to the student and create more relational elements. The present invention may be used by a single student wherein the program will simulate the response of a peer or it may promote participation of multiple students by allowing multiple students to each input conversation elements.

Step 120 requires the user to decide whether the student is going to initiate a conversation or whether the simulated peer response is going to initiate the conversation. If the student is to start the conversation, the program moves to step 202 where the student decides whether he is participating in a “one on one” conversation or group conversation. If the student is by himself, then the student should pick the conversation to start in step 204 with a simulated peer.

A scenario is presented to the student through pictorial depictions. For example, FIG. 7 shows a picture of children camping and gives the student multiple dialogue options on how to start the conversation with others during the camping trip. Because it is the student who is to start the conversation, the program in step 208 waits for the student's selection of what he thinks is the proper way to start the conversation with the virtual or synthetic peer “Justin.” In this case, the choice “Hi Justin” is the correct way for the student to start the conversation. However, if the student picks the wrong choice, step 216 is initiated which will play a wrong answer audio hint associated with the wrong choice and then loop back to step 206 which then loads the next conversation. Alternatively, step 206 may also simply reload the current conversation options.

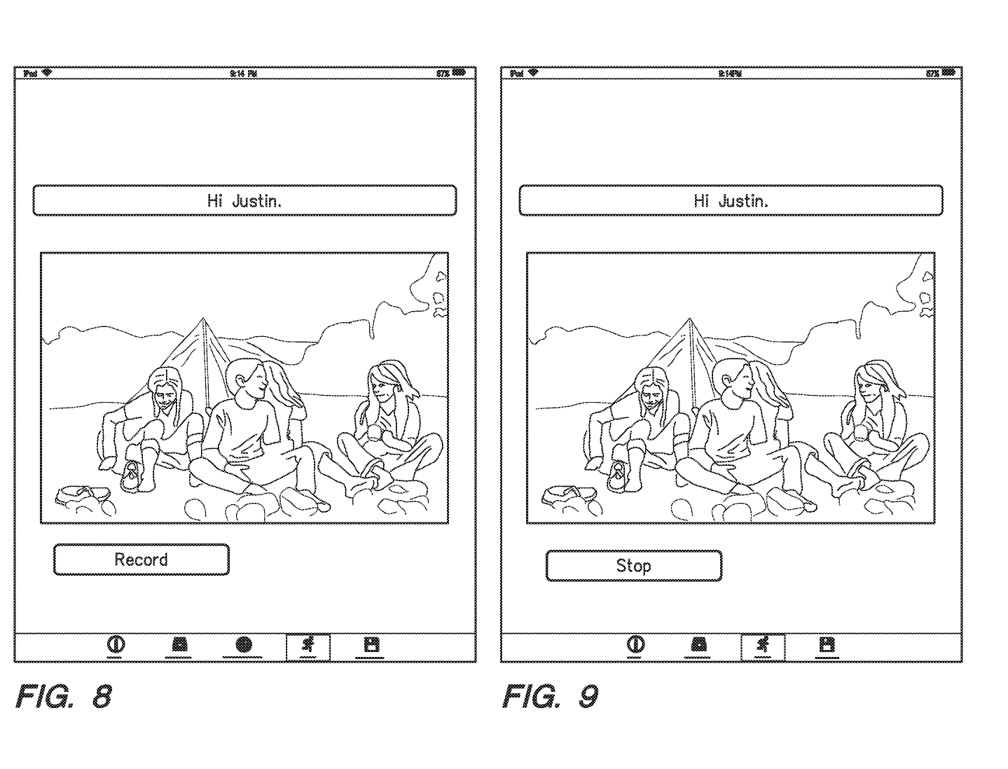

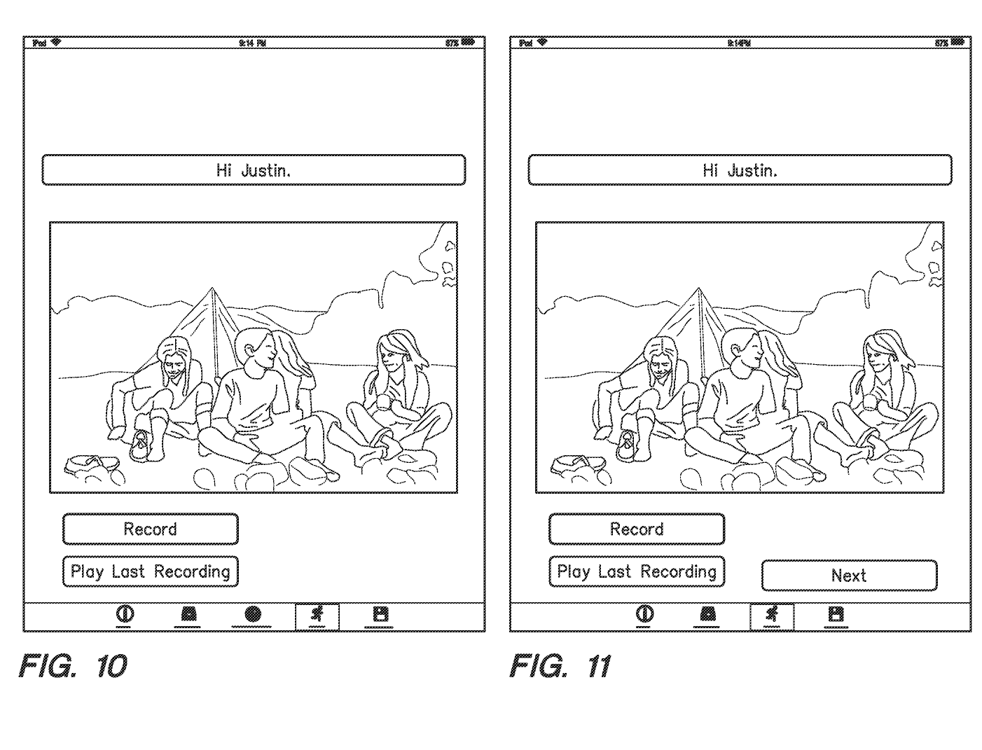

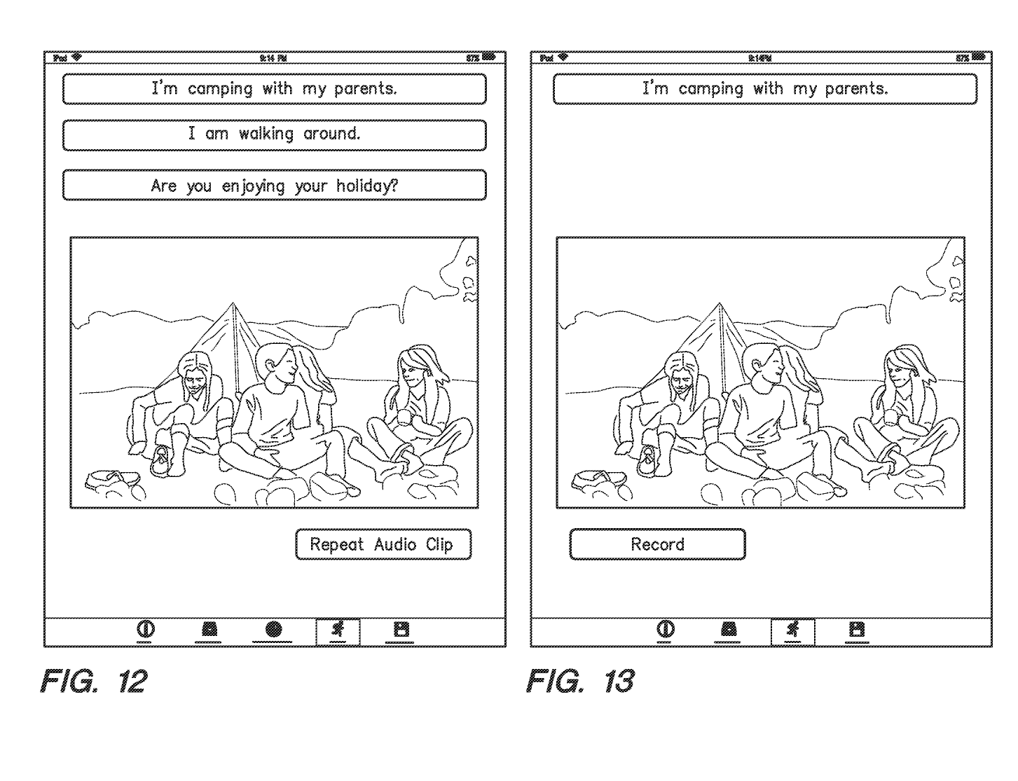

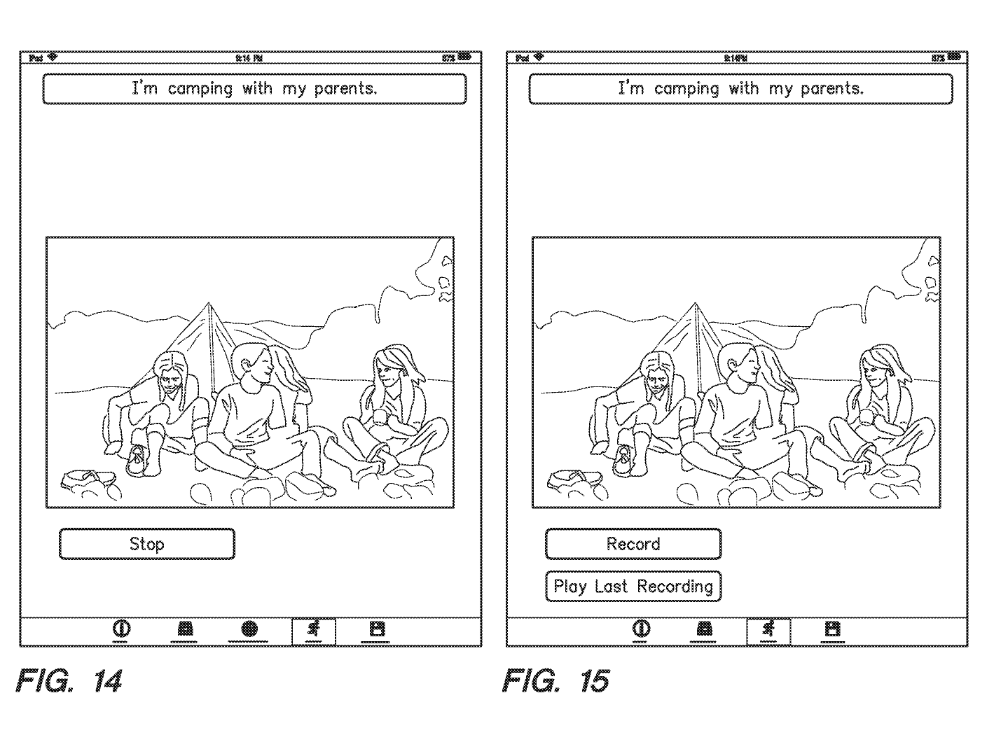

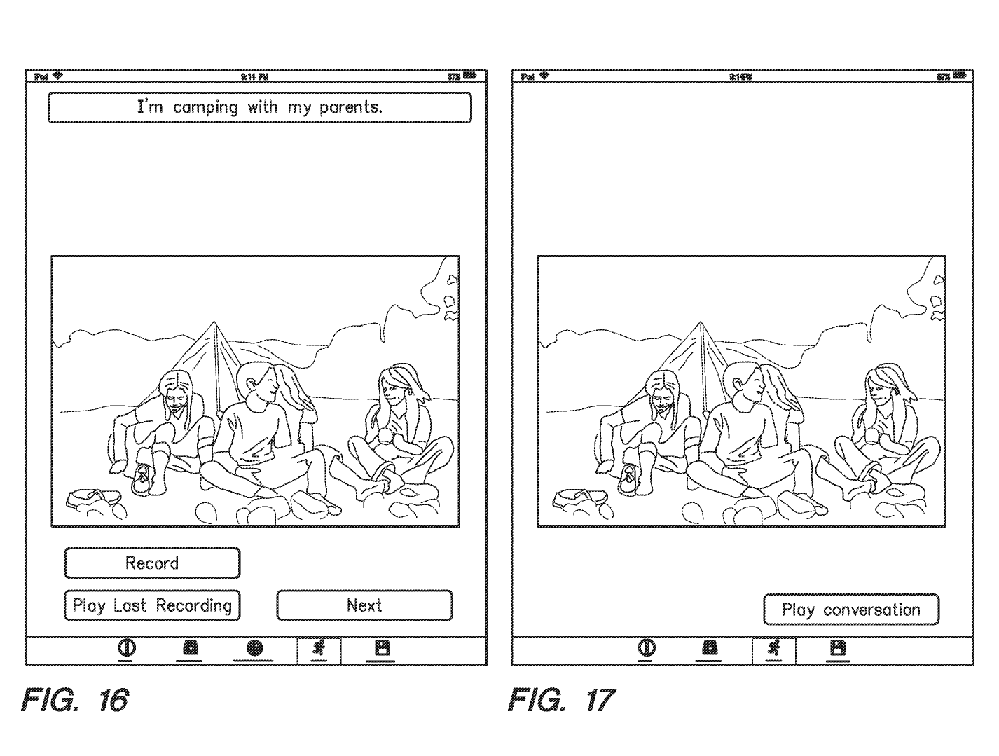

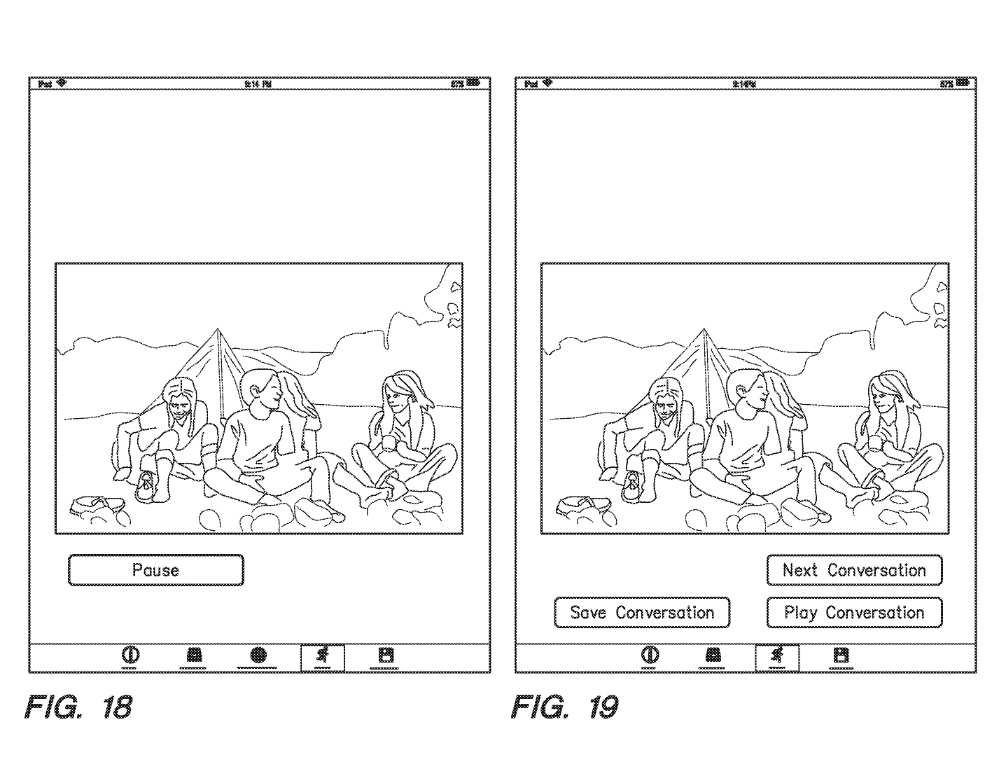

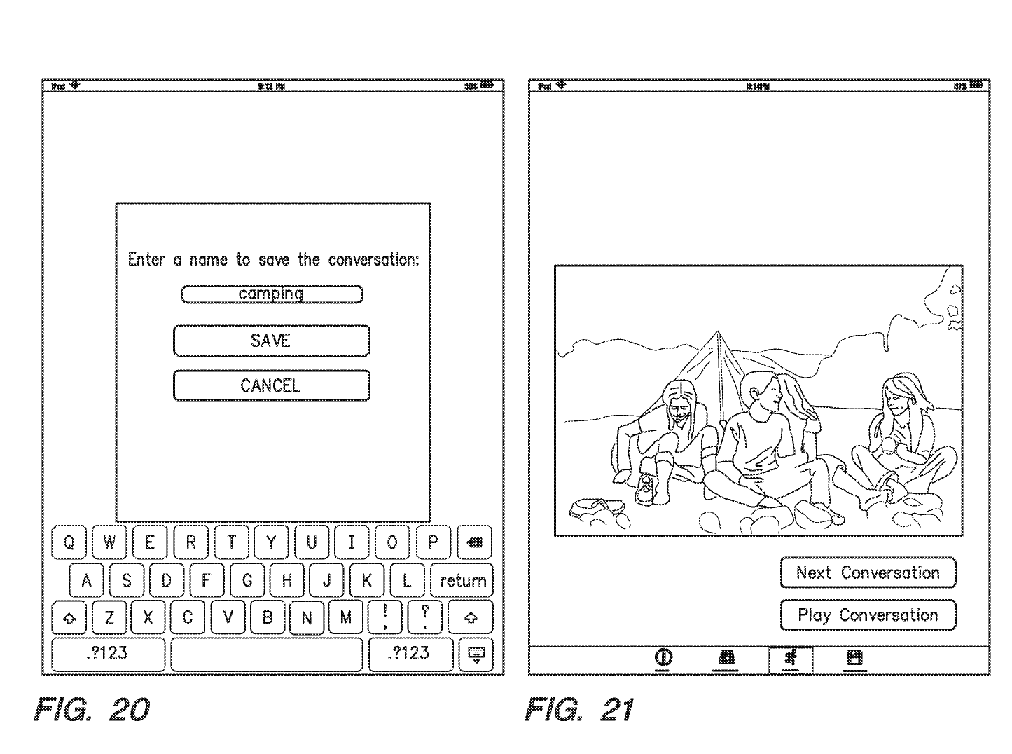

When the student picks the correct answer, step 218 is initiated which hides the wrong answers and displays only the correct answer as shown in FIG. 8. Then step 220 will play the correct answer in audio form for the student to reinforce the selection and proper behavior. Next, step 222 as seen in FIG. 8 will show a record button for the student to select. The student is then allowed to record in his or her own voice the correct answer (see step 224). The student can listen to his or her own recording and repeat the recording phase until they are satisfied with the recording. Once the student finishes the recording in step 228, they can hit the next button as seen in FIG. 16 which then initiates step 230. Step 230 will play a pre-recorded simulated peer response to the Student's initial conversation starter. In this example the pre-recorded response may be something in the line of “Hi, its nice to see you. What are you doing here?” The program will then loop back to step 204 and load the next conversation screen for the student to select the next response as seen in FIG. 12. Once again steps 204-238 are repeated for the new choices shown in FIG. 12-19. The student is once again allowed to record the correct answer which in this case is “I'm camping with my parents.” The student can continue the conversation until all the conversations elements have been executed or at any time the student may end the conversation in step 232 and save the conversation as seen in FIG. 19-20. At the end of the conversation sequence, the student may play the entire conversation with all recorded elements by hitting the play conversation button as seen in FIG. 19. The ability for the student to interact with a simulated peer throughout the conversation sequence and then listen to the entire sequence with the student's own recorded voice during steps 224-228 is a unique point of novelty not found in the prior art.

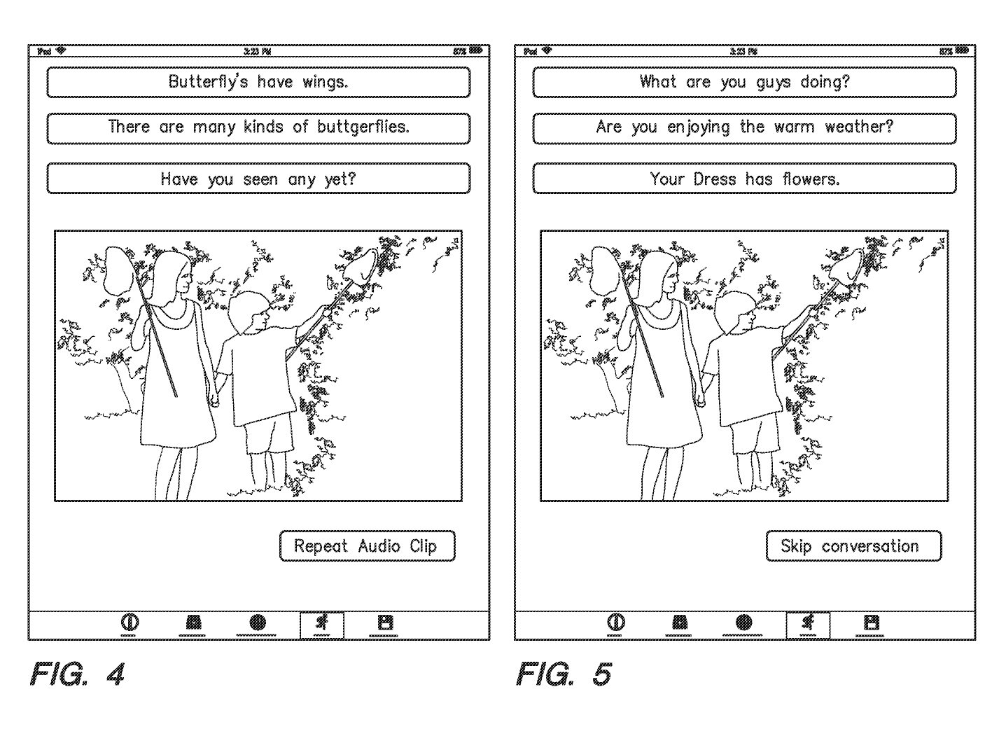

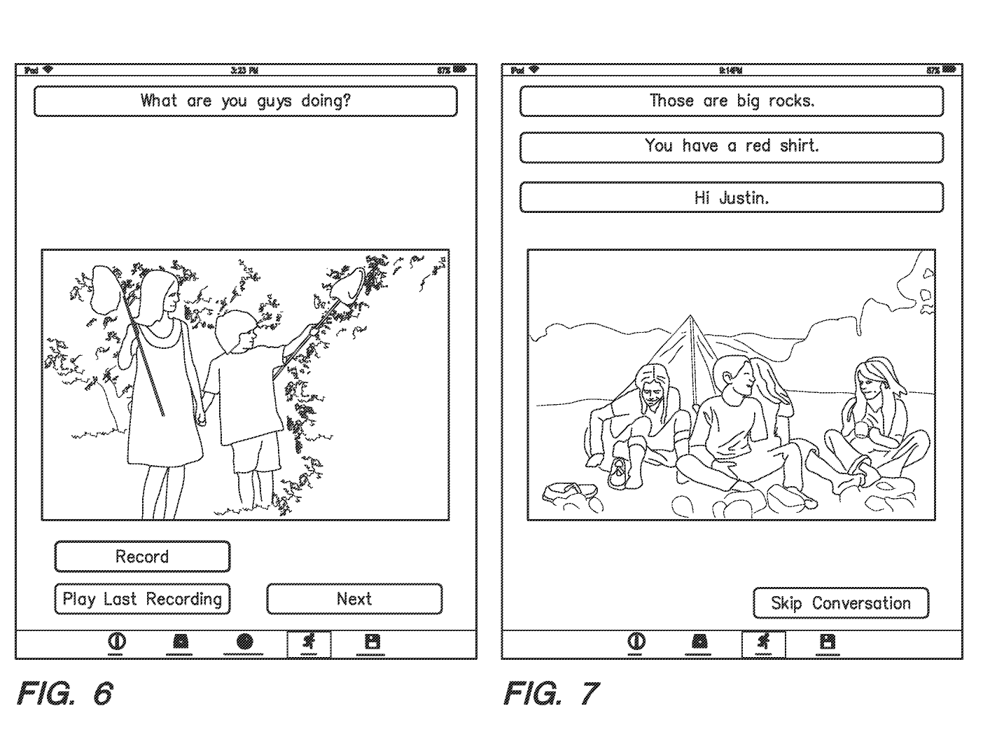

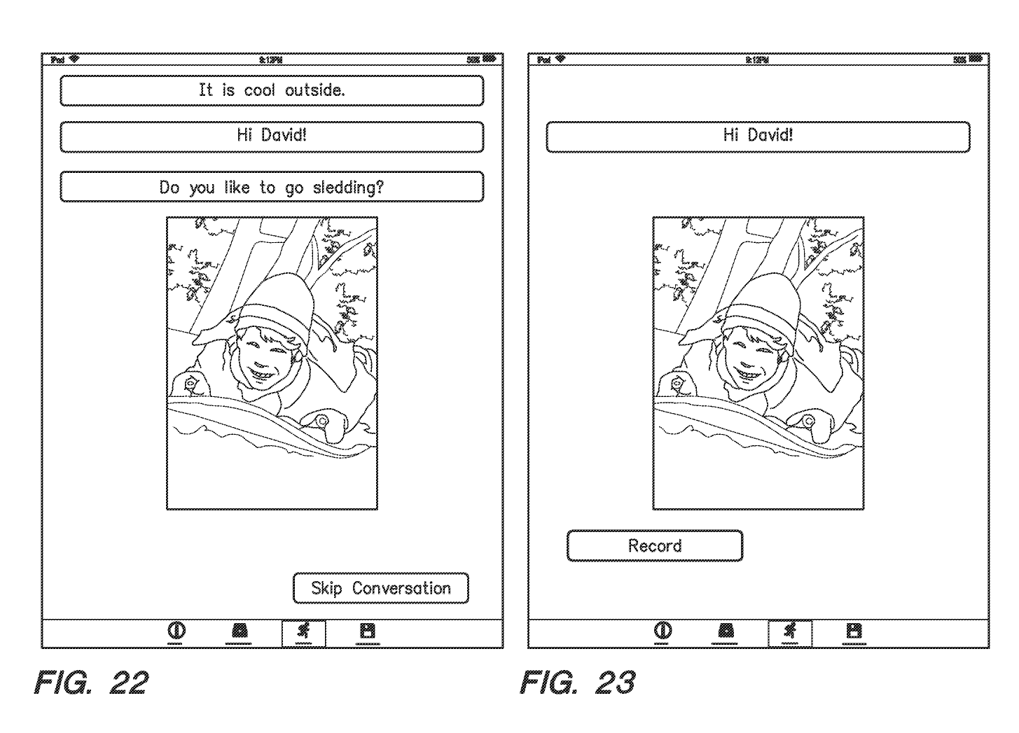

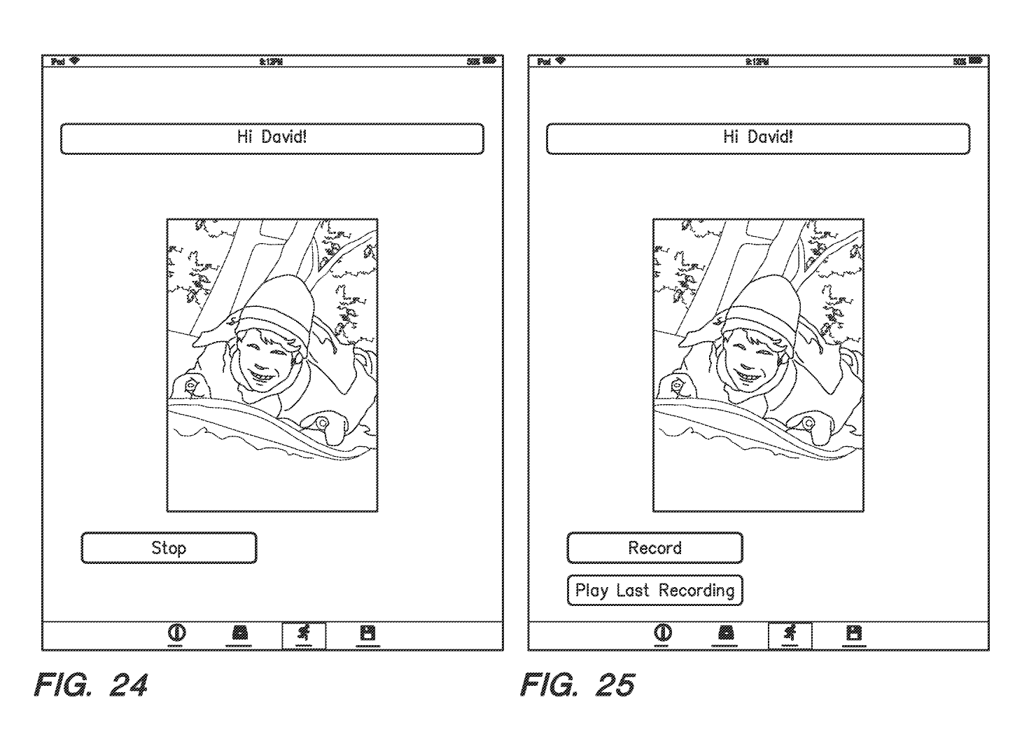

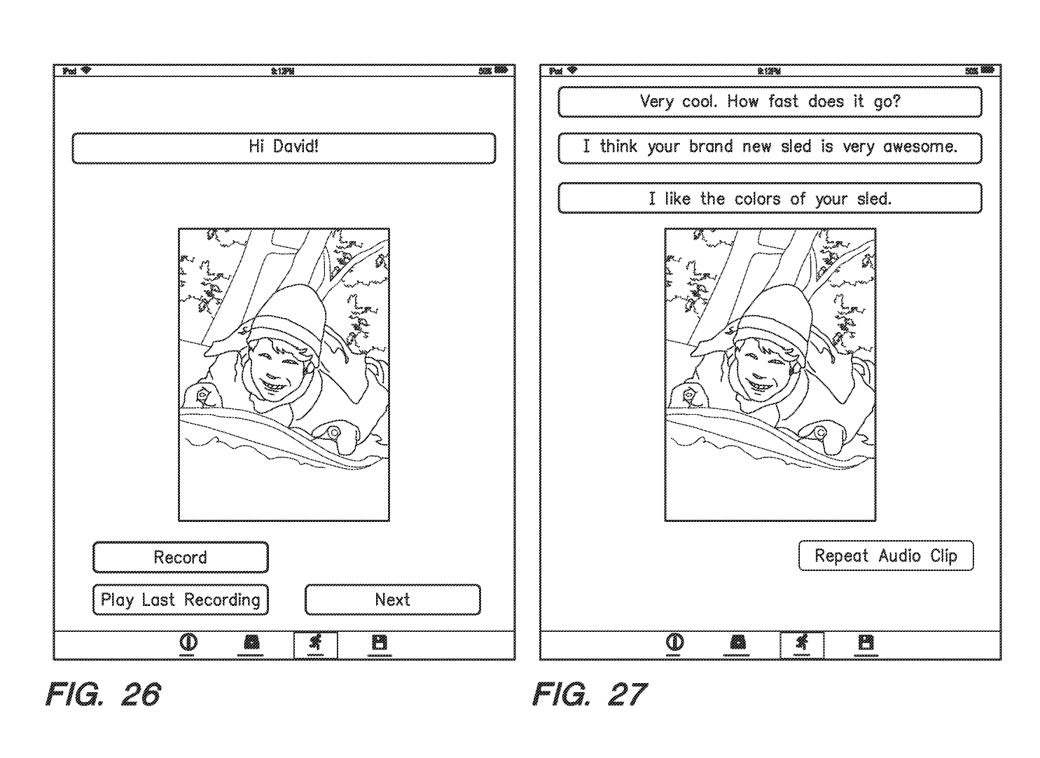

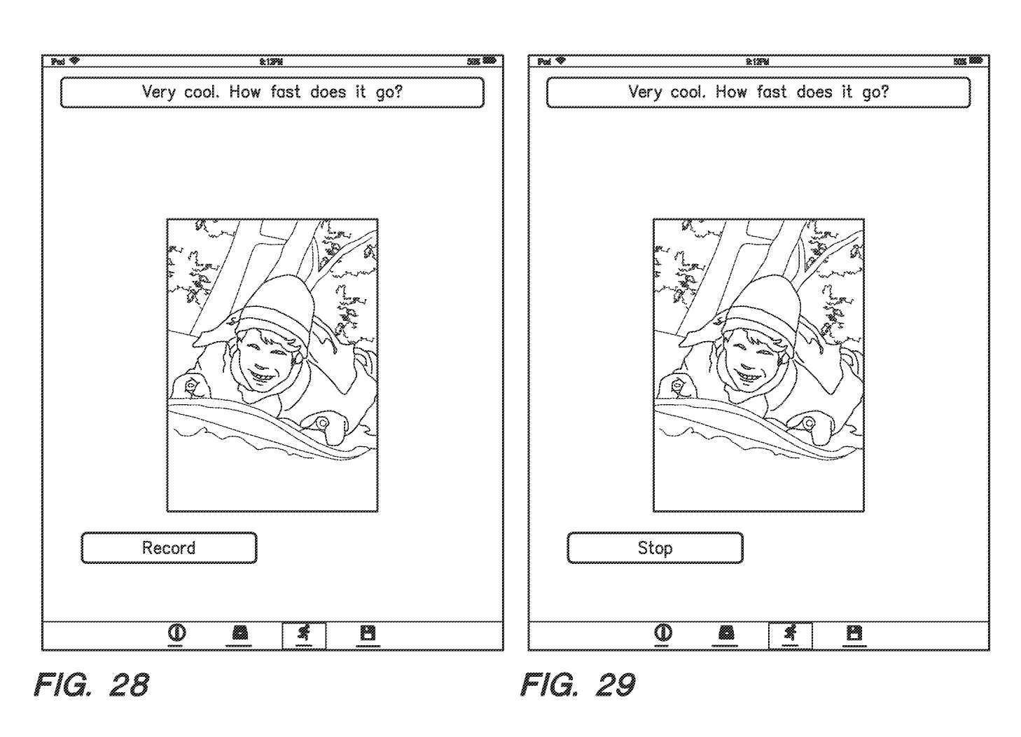

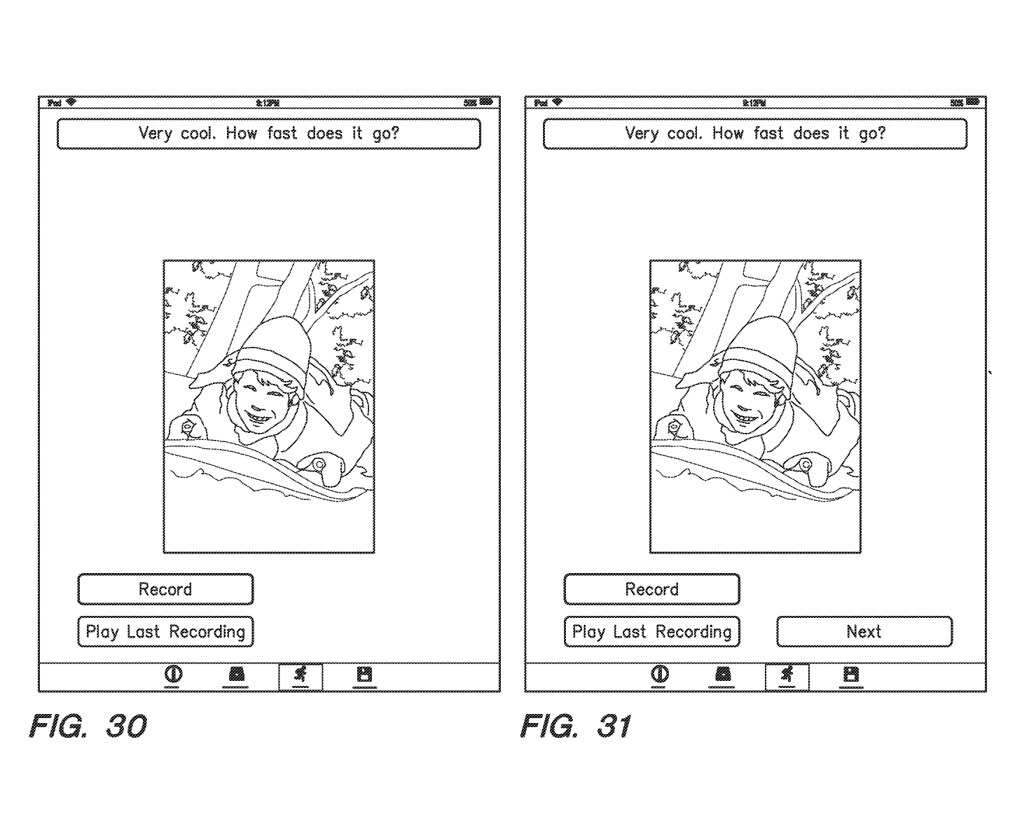

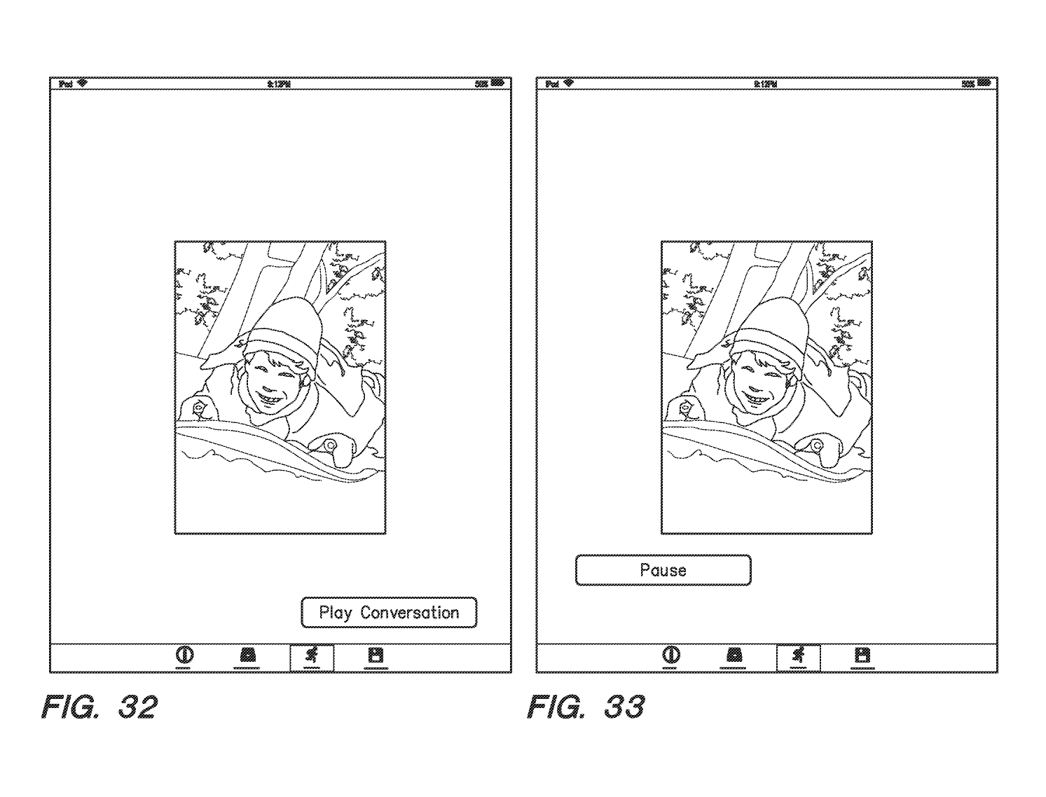

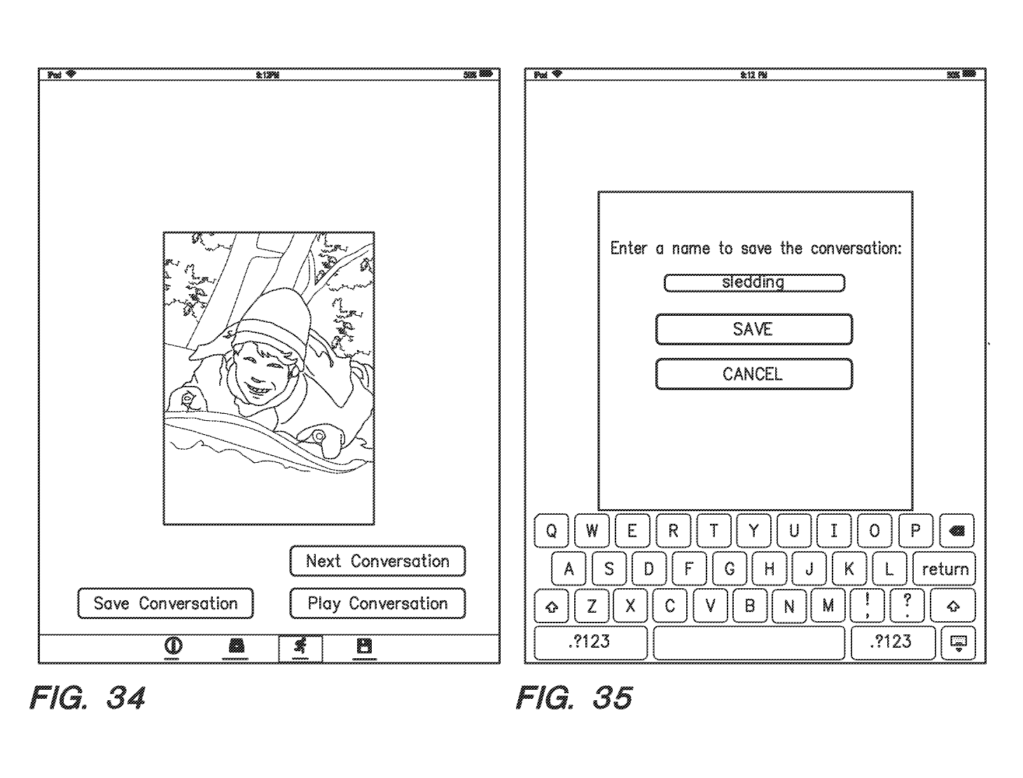

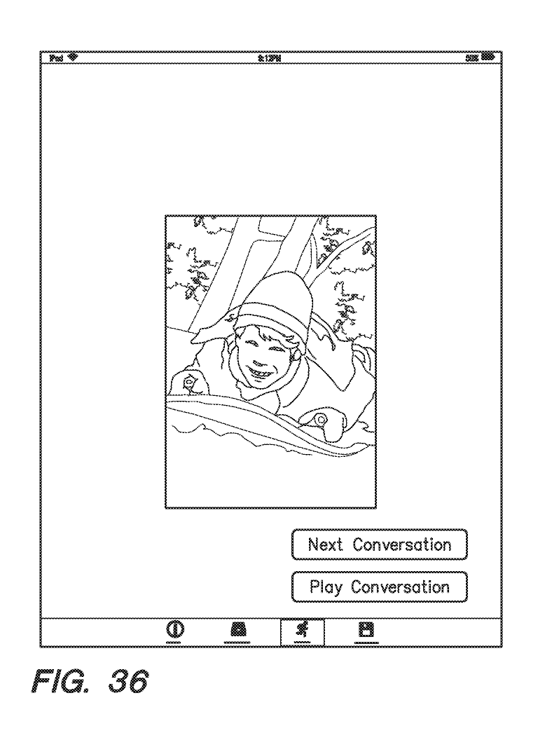

FIGS. 22-36 are screen shots of another scenario focusing on how to start a conversation regarding sledding. FIGS. 4-6 are screen shots of yet another conversation scenario regarding catching butterflies. Once again, the subjects of conversation are boundless and should not be limited to any particular embodiment and may be tailored to cultural elements, social events, specific environments, and even technical fields. The novelty of the present invention is not the dialogue of any particular conversation but is instead the ability to provide the structure and algorithm to allow student interaction and the ability for the student to easily record his own vocal answers and play back an integrated conversation which drastically increases the cognitive behavior and retention of the student.

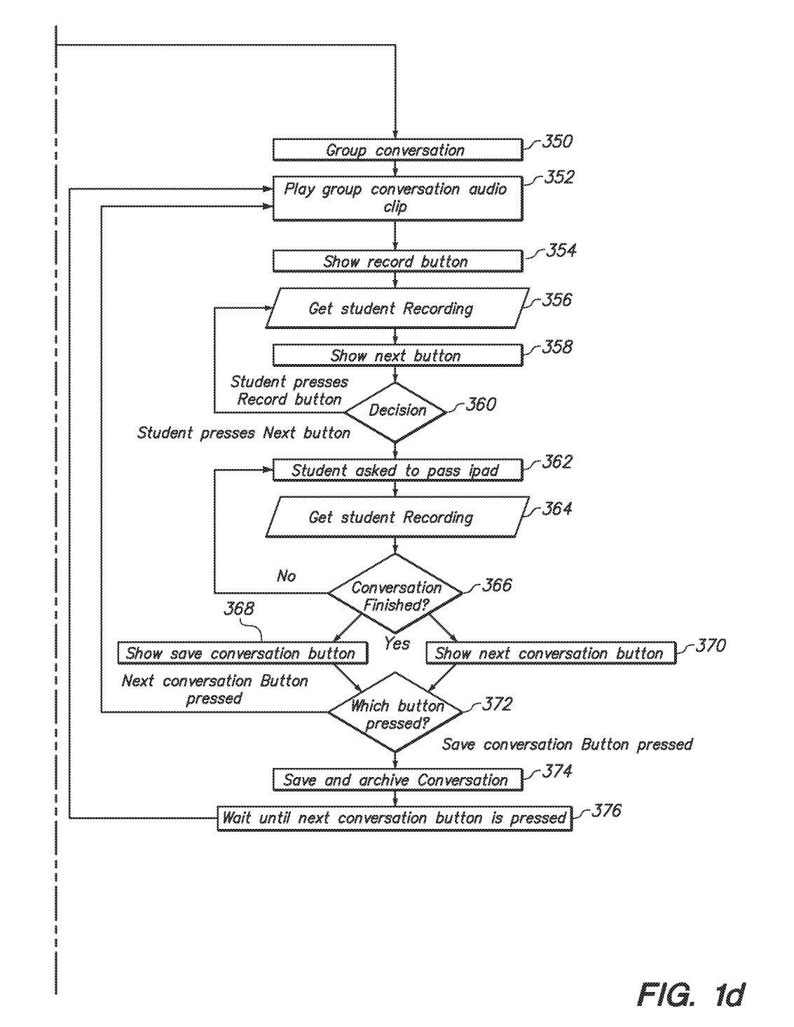

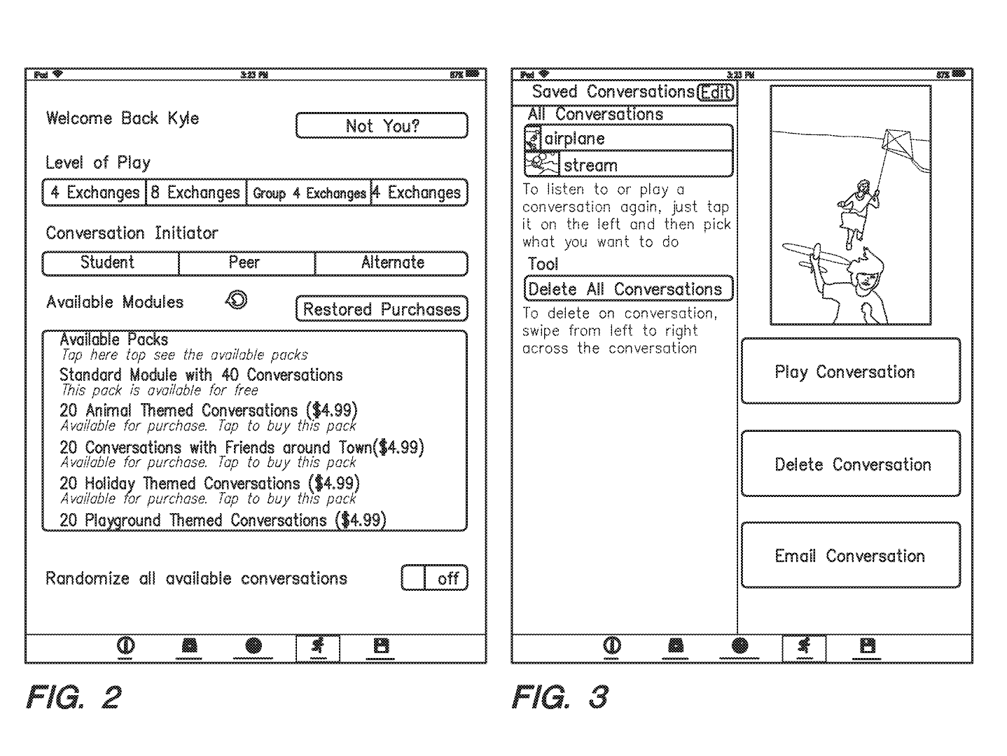

The present invention may also coordinate the interaction of multiple students. For example in step 202, if the student chooses group exchange as seen in FIG. 2, then the present algorithm will follow steps 250-276. In this case, multiple students in sequence are presented with a scenario similar to the single user mode, except instead of interacting solely with the simulated peer, the students interact with each other or with each other and with the simulated peer. In this case, the first student would follow steps 250-260 which is very similar to steps 208-228. The first student picks from multiple options containing either a conversation starter or a response to a peer initiated conversation. Once the first student picks the correct response, they are once again allowed to record that respond using his or her own voice. Once the student is satisfied with the recording, the student is asked in step 262 to pass the iPod or similar device to a second student who will go through similar steps in recording their response to the first student's input. The multi-user option allows multiple users to carry on a conversation and allows each user to record and integrate their answer into the conversation sequence. At the end of the conversation sequence, the students are allowed to play back the entire conversation and listen to their own voices integrated within the conversation. Once again, throughout the entire process the students are given multiple options which continue to encourage participation, cognitive behavior and reinforcement.

FIG. 1 also details steps 300-376. The principal difference in steps 300-376 from that of steps 200-276 is that the simulated peer starts the conversation with a pre-recorded audio clip as show in step 306. The remaining steps are reflective of steps 200-276.

Throughout the specification the aim has been to describe the invention without limiting the invention to any one embodiment or specific collection of features. Persons skilled in the relevant art may realize variations from the specific embodiment that will nonetheless fall within the scope of the invention. For example, although the preferred embodiment refers to students diagnosed with autism, it is understood that the present invention may be utilized to teach students with other learning disabilities such as a speech impediments. In addition, social awkward children without learning disabilities can benefit from the simulated conversations.

While the focus of the preferred embodiment is to permit those with social impairment to learn proper methods of traditional social interaction, the disclosed methods can be useful in learning any kind of interaction by anyone, including cross-cultural, political and even proper interaction within technical fields. Cultures, professions and areas of expertise often have unique mannerisms and social norms. Methods, such as the disclosed invention allow students to learn proper methods of interaction across a broad range of areas.

As such, this specification and the included figures, are not intended to limit the scope of the disclosed invention but are advisory to assist in understanding the broader scope of the disclosed invention, and as such should be read as instructive and not defining or limiting as the full scope of the invention is defined by the claims below.

I Claim:

1. A method for educating a one or more students comprising an auditory input phase and a feedback phase, wherein said one or more students is presented with a one or more settings, each of said settings comprising a multiple of responses with an input means that includes the recording of said one or more students' voice response with the election of one of said multiple responses for each of said one or more settings and a playback of a generated dialog which incorporates said one or more students' voice in said generated dialog.

2. The method for educating a one or more students of claim 1 wherein the said input phase and said feedback phase is accomplished by means of an iPhone/iPad type application.

3. The method for educating a one or more students of claim 1 wherein the said one or more students may select from a plurality of conversation elements and save completed conversation sequences.

4. The method for educating a one or more students of claim 1 where in said generated dialog includes both said multiple responses by said one or more students incorporated with the dialog of a simulated peer in said generated dialog.

5. The method of claim 4 further comprising the added steps of providing for multiple simulated peers.

6. A method for educating a one or more students comprising the steps of
a. providing an auditory input phase with a one or more options on a scenario of a conversation to be simulated;
b. allowing either the student to start said conversation or a simulated peer to start said conversation;
c. presenting the student with said one or more options as to what the student thinks is a proper response to said scenario;
d. recording an audio response by a student selected from said one or more options; and
e. playing said audio response integrated with said simulated peer within said conversation.

7. The method in claim 6 for educating a one or more students further comprising the steps of:
a. providing a multiple of auditory input phases, each of said multiple of auditory input phases with a one or more options on a scenario of a conversation to be simulated for each of said multiple of auditory input phases;
b. allowing either one of said one or more students to start said conversation or said simulated peer to start said conversation;
c. presenting said one or more students with said one or more options as to what said one or more students thinks is a proper response for each of said auditory input phases;
d. recording an audio response by said one or more students for each of said auditory input phases; and
e. playing each of said audio responses integrated within said conversation providing a complex conversation to be simulated.

8. A method of education comprising the steps of providing a one or more students with a one or more visual reinforcement images; providing said one or more students with a text associated with said one or more visual reinforcement images; providing a dynamic interaction means; and providing a student sourced auditory input and playback means for reinforcement of material to be learned by permitting said one or more students to hear a sequence generated with their own voice.
